(19) United States
(12) Patent Application Publication
(10) Pub. No.: US 2023/0292739 A1
(43) Pub. Date: Sep. 21, 2023

(54) Interchangeable Game Disk Call

(71) Applicant: Liberty Game Calls LLC, Anaconda, MT (US)

(72) Inventor: Daniel Ady, Garden City, ID (US)

(21) Appl. No.: 17/655,070

(22) Filed: Mar. 16, 2022

(51) Int. Cl. A01M 31/00

(52) U.S. Cl. CPC A01M 31/004

(57) ABSTRACT

An interchangeable game call disk for use with a game call. The interchangeable disks can be used with external or internal reeds. The devices utilize a carriage and a removable disk. The carriage is configured with a reed, either removable or affixed, that is positioned and configured on the carriage to generate a sound when air is blown across the reed. The disks each has one or more geometric designs that are utilized in conjunction with the reed to create a unique sound. In one embodiment has a pair of flexible external arms that secure the disk into the carriage when in an engaged position. This embodiment is to be secured to an external tower housing to provide a game call. In a second embodiment, the disk has a valley formed in one side that is configured with a unique geometric design. The carriage is configured with a guide slot on an underside that receives the disk therein. Alternatively the disk is configured with clips that slide onto the frame of the carriage. The carriage and reed are typical mouth reeds utilized, for example, in turkey hunting or elk hunting. This embodiment can be used as an internal diaphragm game call.

### TECHNICAL FIELD

The presently disclosed technology relates to game calls. More particularly, the present invention is a device with interchangeable game call disks.

### BACKGROUND

Game calls typically include a reed and a housing with a structure below the reed that serves the purpose of making the call user friendly. Another type of game call is a diaphragm call. Diaphragm calls require no housing and fit entirely within a user's mouth without any external obstructive material to get in the way. The reed is typically made from a latex or silicone material.

Most game calls have a reed and a fixed structure under the reed to illicit certain animal sounds. The structure under the reed of an external game call or diaphragm call are permanent. The permanent platforms or structures under the reed typically have a predetermined sound that will be produced. The permanent platforms or structures can be dome shaped, contoured, rectangular, or any geometric design that allows the reed to oscillate at a different frequency above the structure.

Some highly skilled users are capable of producing multiple frequencies, scales, tones and sounds using these game calls. However, the average user can be at a disadvantage due to the fact they are unable to produce a multitude of different animal sounds by using one designated call.

A plethora of game calls exist that vary in function and operation. One type of game call utilizes a reed positioned within a tube-like device. A user blows into the device, causing air to pass over the reed and generating a sound. This can be referred to as a type of an external game call. In contrast, internal game calls can be positioned within a user's mouth. One such call is often referred to as a mouth reed. A mouth reed typically has a rigid frame component generally in a U shape or similar shape to match the contour of the palate of a human mouth. The mouth reed generally has a flange of more flexible material extending from the rigid frame such that the flexible material creates a concentric U-shape with the U-shaped rigid material. The flexible material is often trimmed to fit the specific user's mouth.

The mouth reed is positioned between the palate of the mouth, the tongue, and within a perimeter of the mouth defined by the user's upper row of teeth. A user then blows air across the reed, causing the reed to emit a sound to mimic the sound of the game animal, for example but not limited to, a turkey yelp, deer bleat, or elk bleat or bugle.

### SUMMARY

The purpose of the Summary is to enable the public, and especially the scientists, engineers, and practitioners in the art who are not familiar with patent or art terms or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

The embodiments described herein relate to a device having interchangeable game call disks. The device allows a user to change the disks of the game call to produce differing game call sounds. In particular, the interchangeable game call device has a disk, a reed and a carriage. The carriage is designed to receive a removable and interchangeable disk. The reed is positioned in the carriage such that air blown across the reed causes the reed to oscillate, producing a sound. The disk is positioned below the reed and controls or limits the oscillation of the reed. The disk is designed or configured with a particular geometric design. The particular geometric design of the disk corresponds to a particular sound to be produced. The carriage can use a removable or affixed reed.

In a first embodiment, the interchangeable game call device is configured as an external game call that is used by a user blowing air through the game call to generate airflow across the reed. The disk of the first embodiment has a top side, two opposing sides that are parallel to one another and a backside that is perpendicular to the two sides. The disk also has an external rail that extends the perimeter of the two opposing sides and the backside. Preferably formed at one end of each of the two parallel sides is a pair of notches. The notches are located opposite the backside.

The top side of the disk has the geometric design extending upward on the disc. The geometric design of the top side is configured to produce a specific sound unique to that geometric design.

The carriage is configured to securely receive the disk therein. The carriage has a backside and two opposing sides. The carriage is designed such that opposite the backside is an open face. The backside and two opposing sides of the carriage form an integral slot that extends the internal perimeter of the carriage. The carriage also has a pair of external flexible arms that are integrally attached to the carriage proximate to the backside. The pair of flexible arms in a preferred embodiment extend parallel to one another.

The disk is configured to be inserted into the open face of the carriage. The external rail of the disk is configured to be inserted into the integral slot of the carriage such that each respective sides and backsides of the carriage and disk align together. The pair of flexible arms of the carriage are configured to engage the notches on the disk and secure the disk in the carriage when biased inwards towards the disk.

The pair of flexible arms of the carriage may further comprise a pair of appendages or tabs positioned thereon opposite the backside. The pair of tabs are configured to engage each respective notch in the disk.

A reed is positioned on the carriage. The reed is positioned on the carriage either removably or fixedly attached to the carriage. In one embodiment the carriage has a channel that is configured to receive a reed. In another embodiment the reed is positioned in a cup or depression of the carriage.

The external game call device is configured to attach to a tower housing. The tower housing has a first end and a second end with a hollow body extending between each end. The first end of the tower housing is configured to receive the open face of the carriage. The tower housing is configured to amplify the sound produced when the carriage, reed and disk combination are inserted therein and air moves over them and through the tower housing. The flexible arms of the carriage are configured for placement within the tower housing to secure the disk in place.

The flexible arms of the carriage in this embodiment also have a pair of stoppers. The stoppers of the flexible arms protrude outward along each respective side. The stoppers of the flexible arms are configured to engage the rim of the tower housing, or alternatively a corresponding stopper on the rim or proximate the rim of the tower housing.

Alternatively, the device may be designed as an internal diaphragm game call device. In an embodiment the internal game call device is configured to fit within a user's mouth. The internal game call device comprises a disk, a carriage and a reed. The disk of the internal game call device has an open side, a valley, a top side, a first and second side, and a backside. The valley is formed in the disk proximate to the open side and extends a distance towards the backside. The valley has a geometric design that extends upward toward the top side. The geometric design is configured with the reed to produce a specific sound.

The disk of the internal game call device further comprises a peripheral edge. The peripheral edge extends the perimeter from the first side around the backside and to the second side.

The carriage of this embodiment has an open face, a top side and a bottom side. The top side is configured to receive and secure a reed thereto. The bottom side has a guide slot. The guide slot is configured to engage and secure the peripheral edge of the disk such that the valley of the disk is positioned substantially under the reed.

In a third embodiment, the disc attaches to the internal

n some embodiments of the internal game call device, the carriage is semi-circular. Further, the reed of the internal game call device may be removable. The reed of any embodiments described herein may be made from silicon. Alternatively, the reed may be made from latex.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### BRIEF DESCRIPTION OF THE DRAWINGS

FIG. 1 illustrates a top perspective view of an embodiment of a disk for an external game call device.

FIG. 2 illustrates a top perspective view of an embodiment of a carriage for an external game call device.

FIG. 3 illustrates a top perspective view of an exploded view of the embodiments of the disk and carriage of FIGS. 1 and 2 prior to engagement.

FIG. 4 illustrates a top perspective view of an embodiment of a disk and carriage of an external game call device engaged together but in an unlocked position.

FIG. 5 illustrates a top perspective view of an embodiment of a disk and carriage of an external game call device engaged together and in a locked position.

FIG. 6 illustrates a perspective view of an exploded view of an embodiment of an engaged disk and carriage of an external game call prior to insertion into an embodiment of a tower housing.

FIG. 7 illustrates a perspective view of an embodiment of an engaged disk and carriage device inserted into an embodiment of a tower housing.

FIG. 8 illustrates a first cross sectional view of the embodiment of the external game call device of FIG. 7.

FIG. 9 illustrates a second cross sectional view of the embodiment of the external game call device of FIG. 7.

FIG. 10 illustrates a top view of an embodiment of a disk and carriage of an external game call device prior to engagement.

FIG. 11 illustrates a top view of an embodiment of a disk and carriage of an external game call device in an engaged and unlocked position.

FIG. 12 illustrates a top view of an embodiment of a disk and carriage of an external game call device in an engage and locked position.

FIG. 13 illustrates a zoomed in perspective view of an embodiment of a channel of the carriage.

FIG. 14 illustrates an exploded top perspective view of an embodiment of an internal game call device having a disk and carriage.

FIG. 15 illustrates an exploded bottom perspective view of an embodiment of an internal game call device having a disk and carriage.

FIG. 16 illustrates a top perspective view of an embodiment of an engaged disk and carriage of an internal game call device.

FIG. 17 illustrates a side perspective view of an embodiment of an engaged disk and carriage of an internal game call device.

FIG. 18 illustrates a top view of an embodiment of a carriage of an internal game call device.

FIG. 19 illustrates a top view of an embodiment of a disk of an internal game call device.

FIG. 20 illustrates an exploded perspective view of an embodiment of a disc and mouth reed.

FIG. 21 illustrates a assembled perspective view of the embodiment of a disc and mouth reed of FIG. 20.

FIG. 22 illustrates a bottom view of the disc of FIG. 20.

FIG. 23 illustrates a bottom view of the disc and mouth reed of FIG. 20.

FIG. 24 illustrates a top view of the disc and mouth reed of FIG. 20.

FIG. 25 illustrates a top view of the disc of FIG. 20.

### DETAILED DESCRIPTION OF THE DRAWINGS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

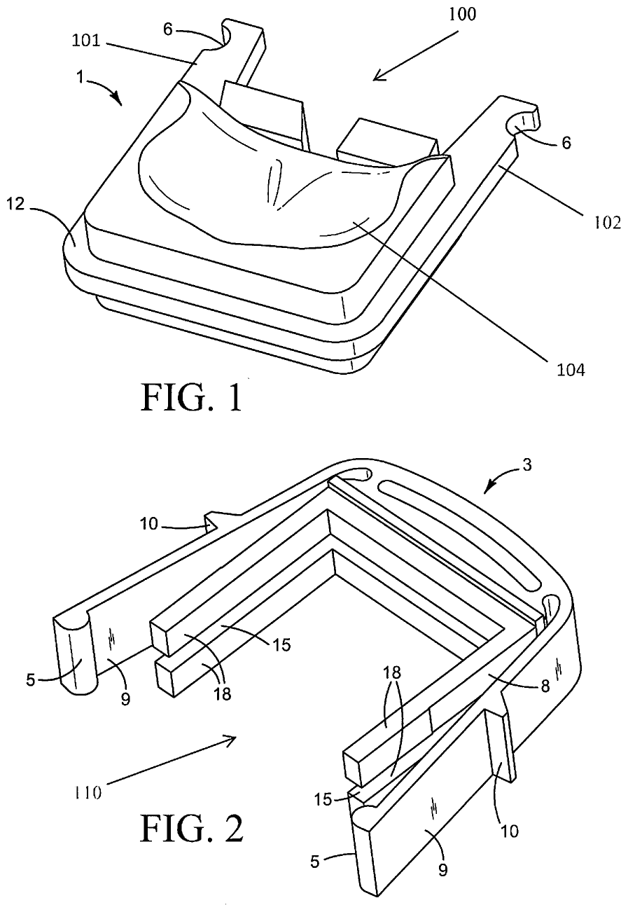

FIG. 1 illustrates a top perspective view of an embodiment of a disk 1 for an external game call device. The disk 1 has an open face 100 that is positioned between a first side 101 and a second side 102. The disk 1 has an external rail 12 that extends the perimeter of the disk 1 from the first side 101 to the second side 102. The first side 101 and second side 102 each have a notch 6. The notch 6 is located proximate to the open face 100. The top side 104 of the disk 1 is configured with a geometric design. The geometric design will produce a specific sound when the reed of the carriage interacts with the geometric design in use. There may be a plurality of differing geometric designs on the top side, with each geometric design being configured to produce a different sound.

FIG. 2 illustrates a top perspective view of an embodiment of a carriage 3 for an external game call device. The carriage 3 is configured to securely receive the disk 1. The carriage 3 has an open face 110. There is an internal channel 15 extending the perimeter of the carriage from one side of the open face 110 to the opposing side. Preferably, the internal channel 15 has a forked front end 18. In the depicted embodiment the internal channel is defined by a disk mounting frame 19. The internal channel 15 is configured to receive the external rail 12 of the disk 1 by aligning the external rail 12 in the forked front end 18 of the internal channel.

The carriage 3 also has a pair of flexible external arms 9. The external arms 9 are preferably formed as an integral extension of the carriage 3. The external arms 9 are integrally attached to the carriage 3 at an end opposite the open face 110. The external arms 9 extend in the direction of the open face 110. Formed at the end of the external arms 9 is an inward facing appendage 5. The appendage 5 is configured to engage the notches 6 on the disk such as to secure the disk in the carriage when inserted therein.

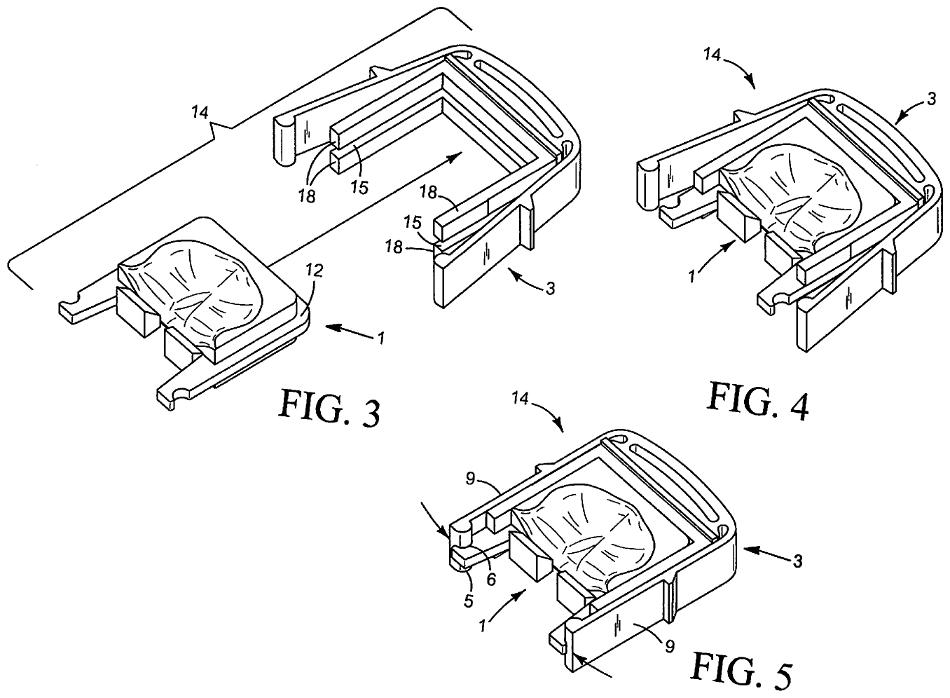

As illustrated in FIGS. 3-5, the disk 1 is inserted into the carriage 3. The external rail 12 of the disk aligns with the internal channel 15 of the carriage. This is illustrated as occurring from FIG. 3 to FIG. 4. After insertion, the external arms 9 are biased inwards such that the appendages 5 of the carriage engage the notches 6 of the disk. As illustrated in FIG. 5, biasing the external arms 9 inwards to engage the appendages 5 in the notches 6 secures the disk 1 in place in the carriage 3. A reed is positioned on or in the carriage. When air travels over the reed, it will oscillate over the geometric design and produce a sound. The disc is configured to control the oscillation of the reed to modify the sound produced by air oscillating over the reed.

In the embodiment depicted in FIGS. 1-9, the reed is positioned on the carriage. In the embodiment depicted in FIGS. 10-13, the reed is positioned in a channel 8 formed between the external arms 9 and the top of the internal channel 15 when the arms are biased inwards. The channel 8 is configured to receive a reed 20. The reed 20 attaches to the carriage such that it sits above the top side 104 of the disk having a geometric design when the disk is inserted into the carriage. The union of the disk 1, carriage 3 and reed 20 results in an external game call 14.

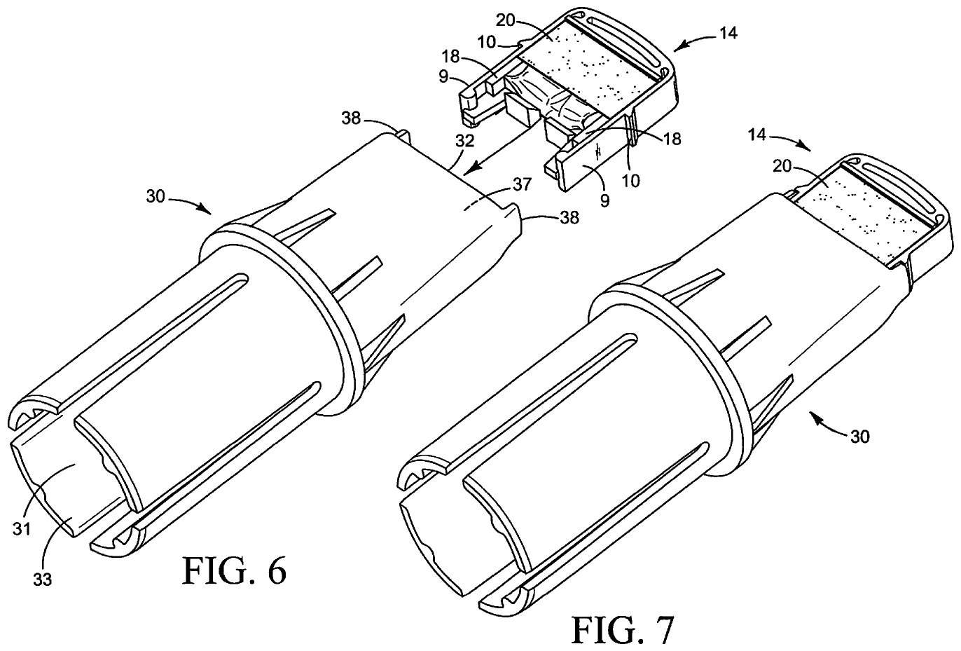

FIG. 6 illustrates an exploded view of the embodiment of the external game call 14 of FIGS. 1-5 inserted into a tower housing 30. The tower housing 30 has a receiving end 37 that is configured to receive the external game call 14. The shape of the receiving end 37 is configured to match that of the external game call 14 such that when the external game call 14 is positioned therein the two are in close proximity.

The external arms 9 of the carriage have a pair of carriage stoppers 10 integrally formed as an external protrusion extending outwards from the carriage. The carriage stoppers 10 are located at an intermediate position along the external arms 9. Proximate to either side of the receiving end 37 are tower stoppers 38. The tower stoppers 38 are configured to engage the carriage stoppers 10 when the external game call 14 is inserted into the receiving end. Engagement of the stoppers stops the external game call from being inserted further into the receiving end of the tower housing.

The receiving end 37 of the tower housing 30 has an air entrance 32. The air entrance 32 connects the hollow body 31 of the tower housing to the air exit 33. The air entrance and air exit are opposite from one another. Air enters the air entrance 32 and travels through the hollow body 31 to the air exit 33.

FIG. 7 illustrates the external game call 14 inserted into the receiving end 37 of the tower housing 30. The carriage stoppers 10 engage the tower stoppers 38 to prevent the external game call device from being inserted all the way into the tower housing.

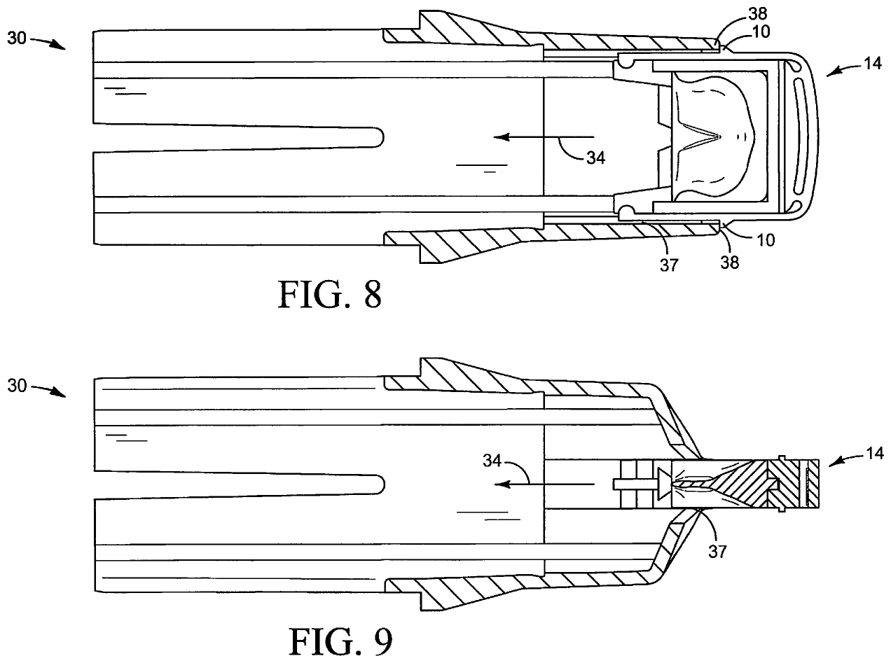

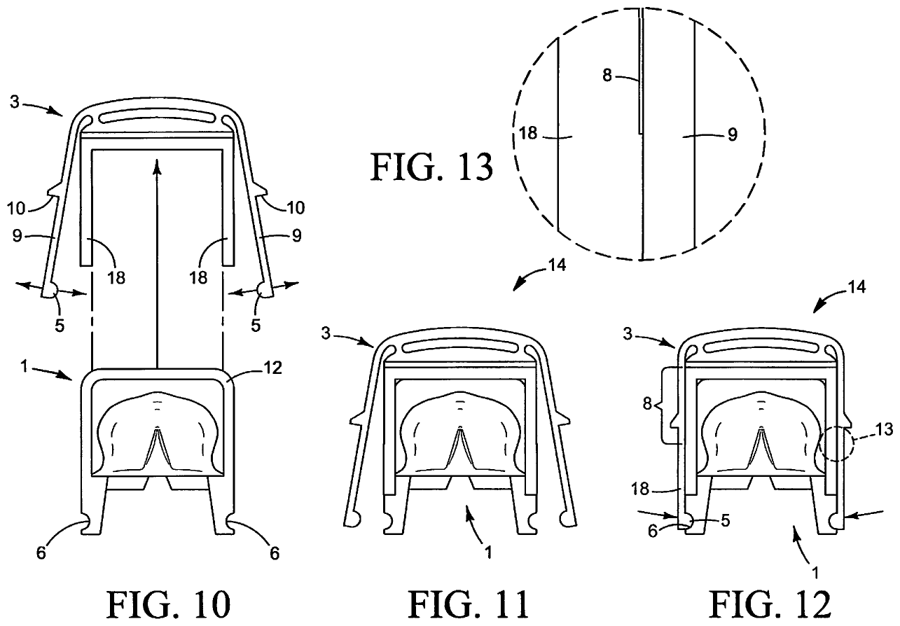

FIGS. 8 and 9 illustrate differing cross sectional views of the external game call inserted into the tower housing. The direction of air flow is indicated by arrow 34.

FIGS. 10 through 12 illustrate top perspective views of the carriage 3 and disk 1. FIG. 10 illustrates a top exploded perspective view of the disk 1 prior to insertion into the carriage 3. FIG. 11 illustrates the disk 1 inserted into the carriage 3 in an unsecured configuration. FIG. 12 illustrates the disk 1 secured in the carriage 3 by biasing the external arms 9 inwards. When biased inwards, the appendages 5 of the external arms engage the notches 6 of the disk.

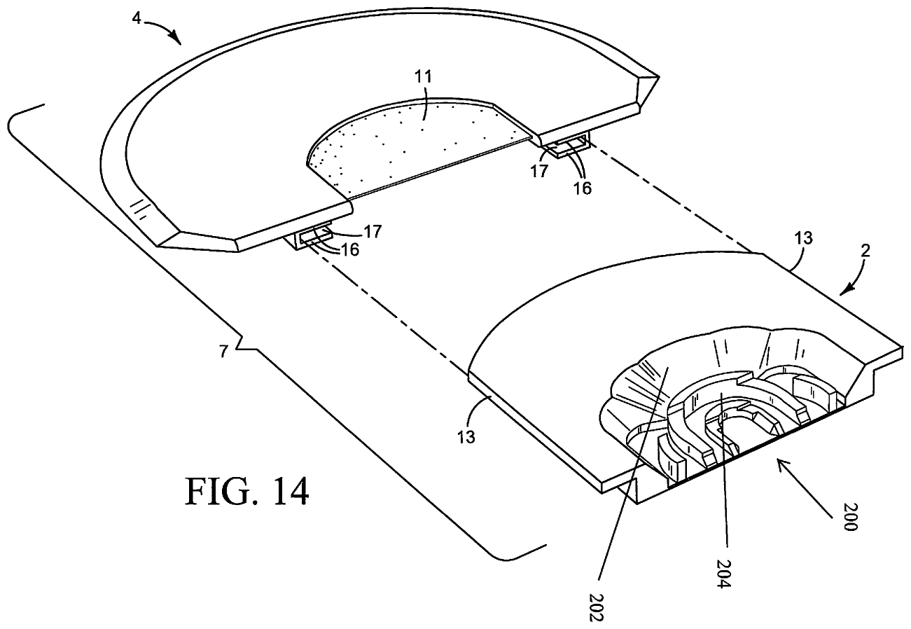

FIGS. 14 through 19 illustrate an alternate embodiment of the invention being an internal diaphragm game call 7 (hereinafter “internal game call”). The internal game call 7 is configured to be inserted into a user's mouth for use, whereas the external game call described above is utilized by a user blowing air through the call.

FIG. 14 illustrates an exploded perspective view of the internal game call 7, commonly referred to as a mouth reed, having a removable disk 2. The disk 2 has an open face 200 formed at one end thereof. The open face 200 has a valley 202 formed therein and extending a distance opposite the open face. The valley 202 is configured with geometric design 204 that will produce a specific sound. Different geometric designs will correspond to different sounds being produced. The disk 2 further has a peripheral edge 13 that extends the perimeter of the disk from one side of the open face to the opposite side of the open face.

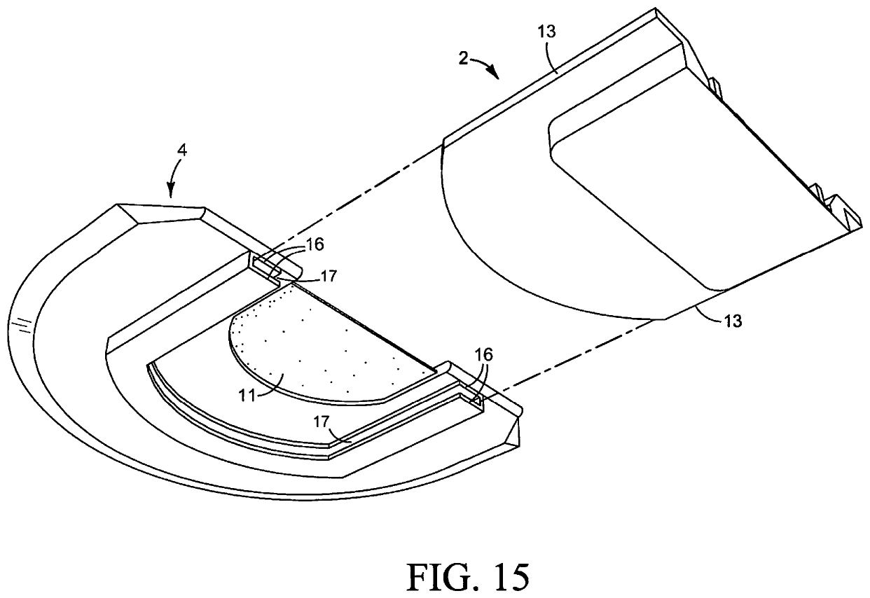

The internal game call 7 also has a carriage 4. The carriage 4 has an integral reed 11 that is formed on the top thereof. As illustrated in FIG. 15, the bottom of the carriage has a guide slot 17. The guide slot is formed from a flange that extends beneath the arms of the internal diaphragm. The guide slot 17 may be formed as a forked configuration or alternatively may be partially enclosed along edges 16. In the depicted embodiment the flange is in a U-shape, although an L-shape or similar shape may be used. The guide slot 17 is configured to receive the peripheral edge 13 of the disk. The guide slot 17 is configured such that the peripheral edge 13 aligns with the edges 16.

The internal game call 7 is configured such that when the disk 2 is inserted into the carriage 4, the valley 202 is positioned under the reed 11. Air will travel over the reed causing it to oscillate over the valley having a geometric design. This will produce a sound unique to the specific geometric design.

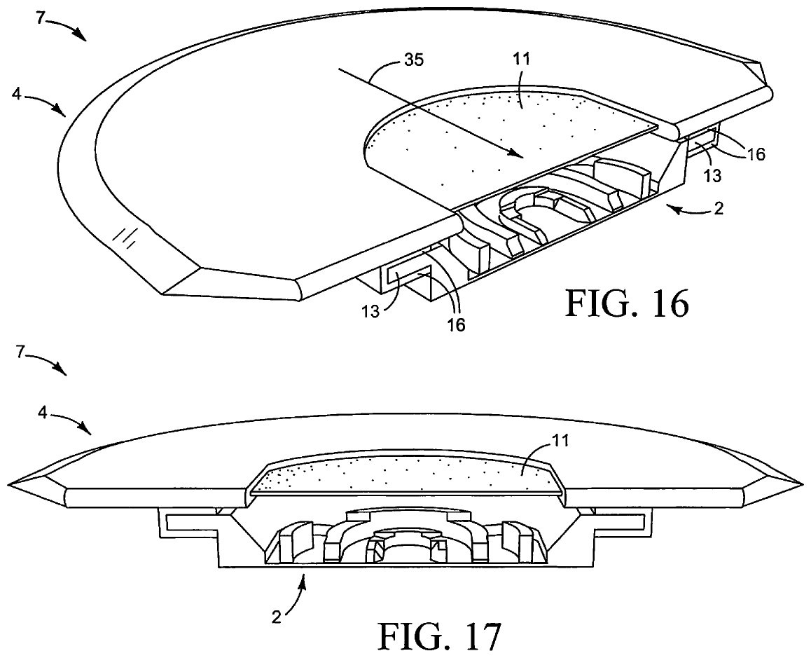

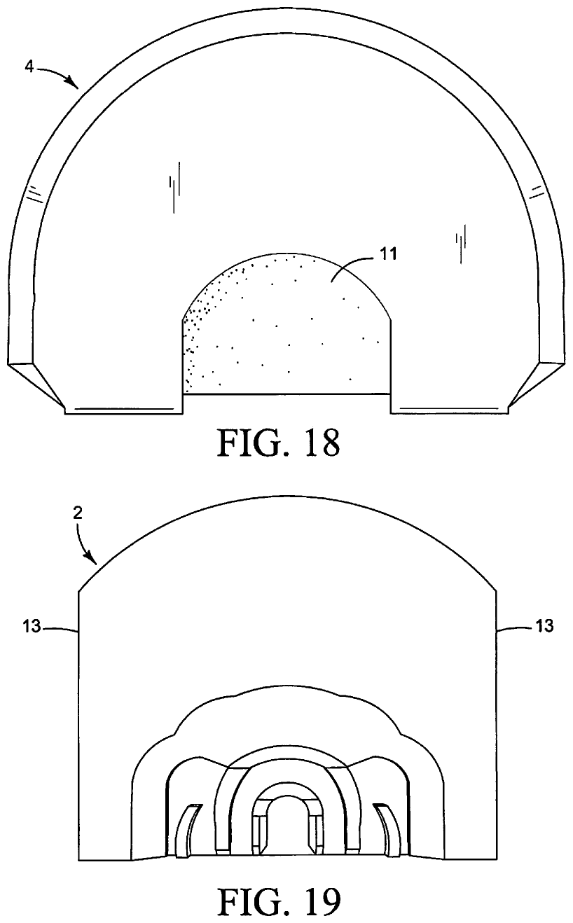

FIG. 16 illustrates a perspective view of the internal game call 7 having the disk 2 inserted into the carriage 4. FIG. 17 illustrates a front view of the disk inserted into the carriage. FIG. 18 illustrates a standalone top view of the carriage of the internal game call. FIG. 19 illustrates a standalone top view of the disk of the internal game call.

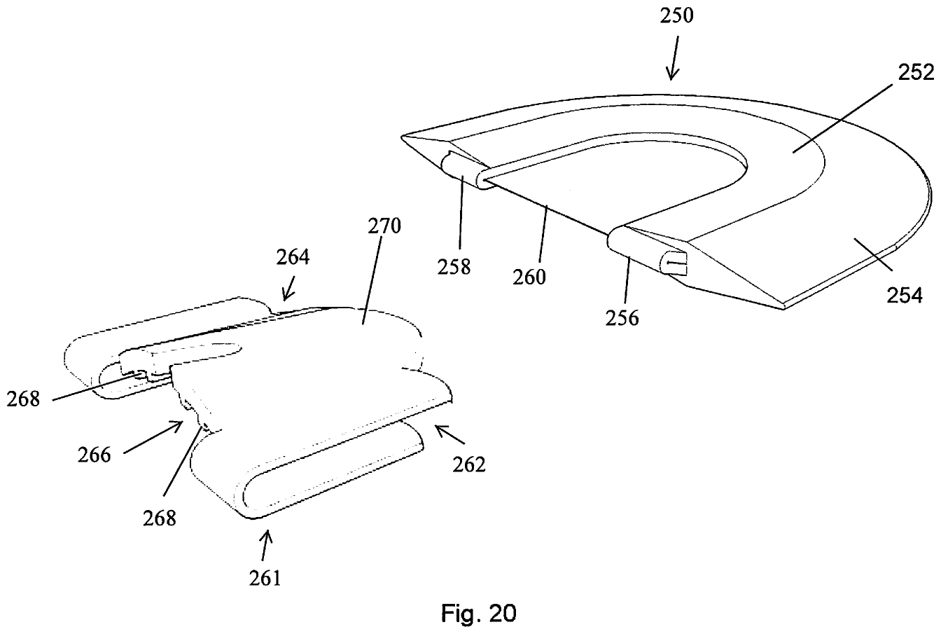

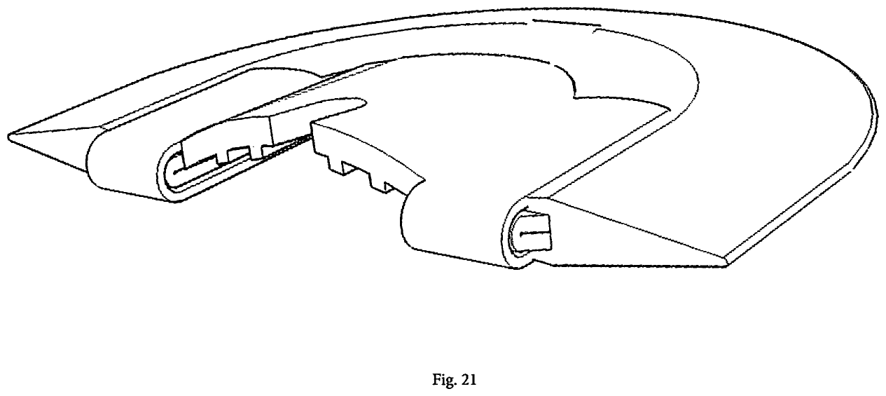

FIG. 20 illustrates an exploded view of another embodiment of an internal game call having a removable disk. The internal game call can utilized a standard mouth reed or can be specifically configured to improve the interaction between the disk and the mouth reed. The mouth reed (called a carriage above) has a rigid frame section 252 and typically a flexible section 254. The reed 260 extends between the arms of the U-shaped rigid section. The depicted embodiment of the reed has two rounded protrusions 256, 258 that are configured for improving nesting of the disk with the carriage. Not all embodiments are required to have the protrusions.

The disk 261 has two clips 262, 263 positioned on opposing sides of the disc. Alternatively the clips can be positioned on the carriage. The clips can be resilient, as depicted, or alternatively as flexible clips or straps. For example, the flexible clips can be attached to the carriage and wrap around the frame or arms of the removable disk. Alternatively the clips can extend upward (or downward depending on the orientation of the carriage) from the carriage and be positioned for sliding engagement with arms of the removable disk. The clips are configured for sliding engagement with the rigid frame section of the carriage. The clips can be resilient, to increase friction between the clip and the rigid frame section. The body 270 of the disc extends between the clips. In the depicted embodiment the body is a dome shape, having geometric configuration being in the form of ridges 266, 268 on an underside of the dome.

FIG. 21 illustrates a perspective view of the disk attached to the carriage. The clips have been positioned on the rigid frame of the carriage, with the protrusions nested in the rounded sections of the clips of the disk. The dome and geometric ridges are positioned to alter the movement of the reed 260 (the reed is removed in FIG. 21) when air is blown across the reed.

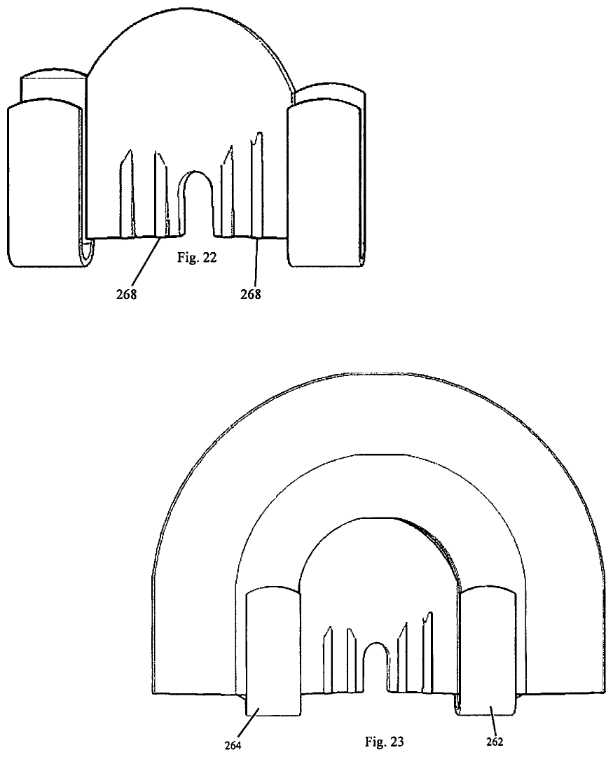

FIG. 22 illustrates the bottom side of an unattached disk of FIGS. 20-21. The geometric configuration of the four depicted ridges varies, with different lengths, widths, and heights available. Alternate shapes can similarly be utilized. Positioning of the disk on the carriage serves to alter the movement of the reed material 260 so as to alter the sound created by use of the reed. The removability of the disk allows for varying the sounds emitted by the mouth reed and allows for variation with the use of one reed.

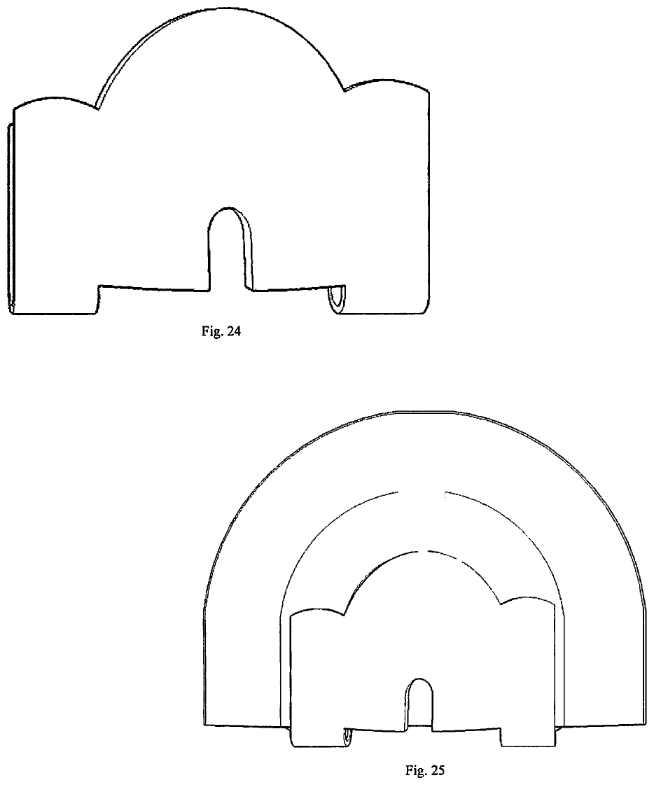

FIG. 23 illustrates a bottom view of the disk attached to the mouth reed, with the reed material removed to illustrate the geometric shapes. FIG. 24 illustrates a top view of a disk. FIG. 25 illustrates a top view of an assembled reed and disk.

The reed of any embodiment described herein is preferably made from a silicon material or a latex material.

While certain preferred embodiments are shown in the figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

What is claimed is:

1. An interchangeable game call device, said game call device comprising:
a carriage, said carriage comprising a U shape having a first carriage arm and a second carriage arm and a reed extending between said first carriage arm and said second carriage arm, wherein said reed extending between said first carriage arm and said second carriage arm and configured for oscillation to produce a sound from air blown across said reed;
a disk removably attached to said carriage, wherein said disk comprises a body having at least one edge configured for attachment to said carriage, wherein said body comprising a central section configured for extending across said reed, wherein said central section comprises geometric features configured to control the oscillation of said reed when air is blown across said reed of said carriage.

2. The interchangeable game call device of claim 1 wherein said carriage is configured for removable insertion into a tower.

3. The interchangeable game call device of claim 1 wherein said reed is removably positioned on said carriage.

4. The interchangeable game call device of claim 1 wherein said carriage and said disk are configured for sliding attachment to attach said disk to said carriage.

5. The interchangeable game call device of claim 4, wherein said disk and carriage are configured for sliding attachment by a slot and rail configuration.

6. The interchangeable game call device of claim 5 wherein said disk comprises said rail, wherein said rail extends along a perimeter of said disk, wherein said carriage comprises said slot.

7. The interchangeable game call device of claim 2, wherein said carriage defines two opposing arms with said disk configured for insertion between said two opposing arms.

8. The interchangeable game call device of claim 7 wherein said opposing arms are parallel.

9. The interchangeable game call device of claim 7 wherein said carriage comprises a disk mounting frame comprising said slot, wherein said disk mounting frame is positioned between said two arms, wherein said two arms are flexible and configured to retain said disk in said disk mounting frame when said arms are in a closed position.

10. The interchangeable game call device of claim 9, wherein at least one of said arms comprises a tab, wherein said disk comprises at least one notch configured for engagement with said at least one tab to retain said disk in said disk mounting frame.

11. The interchangeable game call of claim 6 wherein said rail is continuous around a periphery of the disk.

12. The interchangeable game call of claim 6 wherein said disk comprises two rails positioned on opposite sides of said disk.

13. The interchangeable game call of claim 1, wherein said carriage is configured for internal use within a user's mouth.

14. The interchangeable game call of claim 13, wherein said carriage comprises a slot frame extending from an underside of said carriage and defining a slot extending along said underside of said carriage in parallel orientation to said reed of said carriage, wherein an edge of said disk comprises a rail, wherein said rail of said disk is configured for sliding engagement with said slot to retain said disk beneath said reed.

15. The interchangeable game call of claim 14, wherein said slot extends from an end of the first arm to an end of the second arm.

16. The interchangeable game call of claim 1, wherein said central section of said disc comprises a dome, wherein said dome comprises said geometric features.

17. The interchangeable game call of claim 13, wherein said disk comprises a pair of opposing clips, wherein said opposing clips are configured for sliding attachment to said carriage.

18. The interchangeable game call of claim 17, wherein said clips comprising U shaped clips.

19. The interchangeable game call of claim 17, wherein said clips are resilient.
